(19) United States
(12) Patent Application Publication
(10) Pub. No.: US 2013/0211826 A1
(43) Pub. Date: Aug. 15, 2013

(54) Audio Signals as Buffered Streams of Audio Signals and Metadata

(71) Applicant: Claes-Fredrik Urban Mannby, Mercer Island, WA (US)

(72) Inventor: Claes-Fredrik Urban Mannby, Mercer Island, WA (US)

(21) Appl. No.: 13/589,170

(22) Filed: Aug. 19, 2012

Related U.S. Application Data
(60) Provisional application No. 61/525,846, filed on Aug. 22, 2011.

(51) Int. Cl. G10L 19/00

(52) U.S. Cl. CPC G10L 19/00
USPC 704/201

(57) ABSTRACT

Historically, most audio recording and communication control has been exerted through the use of physical buttons, slider and knobs, e.g. to start/stop recording or communicating, control speaker and microphone volume settings, etc. The present invention describes improvements to this approach, such as detecting and analyzing audio signals with human voice components, e.g. to start/stop recording and communicating, set local and remote recording and playback volumes and filters, and manage metadata associated with temporal ranges in audio streams.

Audio signals have historically been seen as largely real-time, to be analyzed, acted on, recorded, transmitted, etc. immediately. The current invention treats audio signals as a buffered continuum, so that the system has historical access to audio signals and metadata, and may act on both past and future audio signals and metadata.

### REFERENCES

This application incorporates U.S. provisional patent application 61,525,846, Audio Signals as Buffered Streams of Audio Signals and Metadata, filed Aug. 22, 2011, by reference in its entirety.

Some of the technology disclosed in this application is implemented in the following iOS app, developed by the inventor: http://itunes.apple.com/us/app/speakup/id496762516?mt=8

### TECHNICAL FIELD

The described technology is directed at the fields of digital audio recording and digital audio communication, as well as video and audio/video recording and communication.

### BACKGROUND

Historically, most audio recording and communication control has been exerted through the use of physical buttons, slider and knobs, e.g. to start/stop recording or communicating, control speaker and microphone volume settings, etc. The present invention is concerned with some improvements to this approach, with particular focus on detecting and analyzing audio signals with human voice components, e.g. to start/stop recording and communicating, set local and remote recording and playback volumes and filters, and manage metadata associated with points in time and temporal ranges in audio streams.

Audio signals have historically been seen as largely real-time, to be analyzed, acted on, recorded, transmitted, etc. immediately. The current invention treats audio signals as a buffered continuum, so that the system has historical access to audio signals and metadata, and may act on both past and future audio signals and metadata (as they are anticipated, as they become available, in preparation in case they become available, and/or after they have become available).

### BRIEF DESCRIPTION OF THE DRAWINGS

FIG. 1 is a user interface diagram showing two examples of the current invention (with two different user interfaces for the second example).

FIG. 2 is a component diagram showing an example of the current invention.

FIG. 3 is a flow diagram showing an example of the current invention.

### DESCRIPTION

### Overview

A system and method for treating and acting on audio signals as buffered streams of audio signals and metadata is described.

In some embodiments, audio signals are recorded into a large circular buffer, that can store e.g. minutes or hours of audio and metadata. The audio signal is analyzed, locally, remotely or both (not necessarily in real-time), and metadata, such as pauses, consonant sounds, vowel sounds, whistles, claps, background noise levels, counts of identified speakers, etc., is extracted and associated with points and/or ranges of the audio data stream. Auxiliary metadata, such as tags added by users (e.g. through user interface, physical, audio and/or visual gestures), or automatically or manually associated data such as GPS coordinates, camera images, acceleration, gyroscope data, temperature, etc., is also associated with points and ranges of the audio data stream. Higher-level metadata, such as phonemes, syllables, words, numbers, etc., is also associated with points and ranges of the audio data stream.

In some embodiments, the system uses available metadata to prioritize and/or gate other processing, e.g. for efficiency. E.g., speech recognition need not be applied to the audio stream for ranges where insufficient speech-related metadata, such as the presence of single-speaker vowels, is present. Similarly, vowel-detection need not be applied when the audio signal is too weak in volume, or there is too much noise detected.

Historically, most audio recording and communication control has been exerted through the use of physical buttons, sliders and knobs, e.g. to start/stop recording or communicating, control speaker and microphone volume settings, etc.

However, in some embodiments of the present invention, states and state transitions in the audio and/or metadata streams are associated, by the system, a user, other users, or other systems, with actions to be performed by one or more parts of the system. For example, an audio recorder may associate a sequence of metadata, such as a sequence of vowels, with the action of starting the recording of an audio segment commencing 3 minutes in the past, and stopping 5 minutes in the future. As another example, the phrase “umm, hold on” may be associated with displaying a list of recent metadata, for review or interaction. As another example, a particular whistle, such as a wolf-whistle, may be associated with retrieving current GPS coordinates, and transmitting them to other, communicating parties. As another example, a snap of the fingers may be associated with taking a previous arranged audio recording, and sending it to other parties as a phone conversation, email, micro-blog, Web post, etc.

In some embodiments, audio signals are analyzed for human voice signatures, such as the presence of consonants and vowels, and signal-to-noise ratios of such signatures are compared to other components of the audio signal are computed, and the presence of other voices is detected, etc., and microphone volume and equalizer, spectral and other filtering (in both the selection (e.g. selective encoding of most relevant parts) and modification (e.g. amplifying and suppressing different aspects) senses) is adjusted based on this analysis to optimize the quality of the main speaker's voice signal. In some embodiments, such analysis is performed proximate to the speaker, and in other embodiments, such analysis is performed at the receiving end and/or on other systems, such as at a central or distributed computing service.

In some embodiments, microphone and/or hardware speaker volumes, equalizer, spectral and other filtering is performed remotely. E.g., a party to a communication may increase or decrease the microphone volume (or other feature of the recording apparatus and/or any further processing of the audio signals) for another party to the conversation manually (e.g. remotely control the microphone volume of another party), or may control settings of automatic controls (e.g. opting for preferring for the system to optimize for human speech, nature sounds, background sounds, etc.). In some embodiments, a user or a party to a communication may receive a simulated or real feedback of the audio and/or metadata stream as it is, was, will and/or would be received by a different party, as audio, modified audio (e.g. lower volume), visual representation of audio (oscilloscope, FFT graph, second-order FFT graph, sonogram, etc.), metadata, etc., e.g. to self-monitor for optimal perception by another party. In some embodiments, this control is exerted by an automaton, such as an audio communication component of a networked service, such as a search engine, e.g. in order to maximize its ability to clearly transcribe the audio signal as text. In some embodiments, a human party or automaton may provide metadata feedback using facilities provided by the system, or as simple audio or other signals, such as a spoken voice, which may, for example, say “please speak closer to the microphone, and cup your hand around it.” In some embodiments, a communication system component may have user interface elements to make it easy for parties to communicate perceived quality level to other parties. In some embodiments, a component uses naturally occurring gestures, such as moving in closer to a microphone or screen, speaking louder and/or slower, etc., as cues to infer perceived quality level. In some embodiments, user interface elements give visual, auditory, vibrational, etc. feedback instantaneously and/or over time of metadata, such as how well the system and/or other parties are able to extract metadata, such as speech elements and speech. In some embodiments, the system may interrupt, requesting parties to speak up, be more quiet, or make other adjustments to devices, to what they are doing, how they are speaking, etc.

In some embodiments, the following are some of the types of metadata identified and/or available to the system directly related to aural entities (such as vowels, claps, etc.):
overall volume and volume of any of the types of aural entities identified
spectral histograms, densities and other statistics
presence, absence, clarity, confidence of identification of any of the types of aural entities identified
vowels, consonants
speaking or singing voice events, such as transition between registers, breaks, cracks, vibrato, screaming, quavers, richness of overtones
smoothness/unevenness/strain of vibrato, held frequencies, etc
speech formants
base frequency or frequencies of speech
vocal tract shape and size
histogram of overtones
syllables, words, digits, numbers
accents, speaking style
song, music, instruments, percussion sounds
melodies, chords, beats, rhythms, etc.
claps, whistles, finger snaps, dicks, tongue/mouth sounds, flatulence, snores, etc.
sound effects, such as hammer on nail, birds, bees, humming bird, ocean, generic noise types (white, pink, brown, etc), traffic, forest, playground, fire, crickets, city, rain, river, wind, electronic noise, buzz, hum, crying, yelling, barking, etc.

In some embodiments, recording of audio may be started, stopped, analyzed and annotated with metadata by a complex system of triggers based on combinations of metadata, e.g. weighted and combined using a complex formula that may be updated over time, based on positive and negative reinforcement through user feedback, and/or analysis of system performance by humans and/or computer systems. E.g., recording may be normally be triggered by a snap of the fingers, but not if there is a lot of finger snapping detected.

In some embodiments, recording may not start when a metadata- and/or audio-signal-derived state or state transition triggers recording, but may rather start in the past or future, as configured by the system, a user or other entity. For example, recording may be configured to start 3 minutes in the past, and continue 5 minutes into the future unless another state transition happens, causing the duration to be shortened, extended, or split into pieces.

In some embodiments, transmission need not be successful in real-time, but may instead be buffered and re-tried, and a recipient may choose to experience a different representation of the audio signal and/or its metadata, such as a sped-up version of the audio signal, a ticker-display or list of raw or filtered metadata, or have scrubbing control over where in the audio stream to have the experience.

In some embodiments, the system may be involved in a voice-over-IP (VOIP) conversation where party A asks party B for directions to a park. The reception of the audio response from party B to party A may be garbled, e.g. due to a poor wireless connection. In this case, the present invention may, for example, allow the system to add the missing parts of the information stream over time, and allow any of the following scenarios to happen:

A. Hold—When audio is interrupted, Party A reviews the stream of metadata and taps on the one that denotes a pause followed by the directions being provided. Party A listens to a now fully available version of the audio signal. Party B meanwhile is presented with a state display showing that party A is no longer actively listening, and is reviewing the conversation 10 seconds ago, and is likely to resume real-time communications in 10 seconds, e.g. based on a statistical analysis of many users, and the current user, and the pair of users in particular. When party A has finished listening to the description again, they both resume their conversation, either automatically, or through a user interface gesture from party A, or through a request from party B.

B. Metadata recognition—When audio is interrupted, Party A reviews the transcribed text of the description, which has been fully received, since it contains less data. The textual description may be deemed sufficient, or it may be tapped on, showing a map of the address or location described, e.g. based on standard recognition of schema in text, such as regular expressions detecting addresses and place name references (or the map may be shown automatically, based on the system identifying an address in the metadata stream).

C. Metadata transmission—Party B identifies the location on a map, and gestures to have the map transmitted as metadata as part of the conversation. The metadata could be an image from a mapping application, GPS coordinates, a well-formatted address, etc.

D. Metadata transmission—Party B instructs the system to transmit his/her current location to party A, and party A has previously configured his/her system to display such information on a map automatically.

In some embodiments, metadata transmission happens as part of a VOIP or other system that allows the transmission of arbitrary data. In some embodiments, a data channel is opened that is independent of the audio channel. In some embodiments, data is transmitted as part of the audio signal, in a minimally obtrusive way, e.g. based on a feedback mechanism that determines estimated data-audio-signal volumes required for accurate decoding by other parts of the system. In some embodiments, data is transmitted during pauses in the speech, and is automatically filtered out by the components in the system (i.e., the sound signal contains loud, clear data signals, but these are removed from the audio stream before it is passed to a speaker proximate to other parties). In some embodiments, audio data is compressed and merged with metadata, and is sent as a digital signals, which are converted to an audio signal proximate to other parties. This way, the system has the ability to render only parts of the signal, transmit digital information, and use an analog audio connection.

In some embodiments, metadata in the form of text resulting from performing speech recognition is transmitted together with compressed audio, and receiving parties (computer nodes or humans controlling computer nodes) can see the text as subtitles to the communication, can choose between the text and the audio, can manually or automatically control the level of audio compression, microphone levels, audio processing, noise filtering, high-level speech recognition parameters such as vocabulary, language, jargon, style, etc.

In some embodiments, metadata is generated for multiple levels of abstraction, from audio pressure/voltage levels, through sound features, such as voice base frequencies and overtones that persist for short periods of time, frequencies that move up or down smoothly, staccato events, through phonemes, syllables, words, phrases, etc., and transmission of different levels of abstraction is controlled by available bandwidth, requests from receiving parties, confidence scores for higher levels of abstraction (transmitting more lower-level information in case the higher levels are incorrect), manual or automatic feedback regarding accuracy or usefulness of different levels of abstraction. In some embodiments, alternative forms of metadata are provided, with associated confidence levels. Automatic feedback is sometimes generated by looking at language statistics, e.g. in the form of n-grams, or by looking at raw confidence levels generated during the identification of higher level abstractions. Automatic feedback can also be generated by sensing squeezing of handsets, additional proximity of head to a speaker or display, expressions such as “what”, “I couldn't hear that,” swearing, shrugging, shaking the head, and other gestures, hanging up, louder and/or slower speech on sending or receiving end, etc.

In some embodiments, audio data is analyzed to generate different types of metadata based on other generated metadata that can be used to classify different soundscapes. E.g., when human voice is detected (i.e. the soundscape is classified as containing human voice sounds), voice-related features, such as vowels, sibilants and plosives are identified, and metadata generated for those features. In some embodiments, such features are isolated, and lower-level input selection and analysis, including setting of microphone levels, is made based on analysis focused on those features. For example, as distinct from a generic volume value, a voice-related volume value may be generated based on the volume of the aspects of the audio input deemed to come from speech, e.g. by calculating the volume of the frequencies at or close to the voice base frequency and overtones. In some embodiments, differential voice volume is determined by comparing the volume at frequencies at or close to the voice base frequency and overtones with the volume at other frequencies. The volume at a frequency can, for example, be determined by performing a Fast Fourier Transform (FFT) on audio data. Overtones can, for example, be identified by performing an FFT on the first FFT output (i.e. a second-order FFT), to identify recurring intervals between frequencies, or by more direct means, such as finding common intervals between peaks in the first FFT.

In some embodiments, speech profiles are identified, e.g. mapping information such as expected ranges of base frequencies, vocal tract length normalization/warping factors, positions of vowels in graphs of multiple formants against each other, duration of voice features, volume of voice-related features, speed of transition between features, probabilities of sequences of voice features, probability of correlation of sequences of voice features and text, etc. to individual users. Such profiles are then used to generate probabilities for speech features, identifying a change in speaker, multiple speakers, etc. In some embodiments, voice volume is generated specific to an individual speaker. In some embodiments, voice volume is adjusted based on down-stream processing factors, such as ease/confidence/accuracy of speech recognition, ease of comprehension by other humans, etc.

The following is a sample list of user interface gestures and interactions:
Place other party on hold.
Request other party to resume real-time communications.
Request and/or send location information and/or directions,
Send medical status information.
Send mood status.
Filter connections based on metadata, such as mood, voice quality, language spoken, characteristics of phone-spamming systems (such as an initial silence),
Scrub (move around in) the communication timeline.
Review filtered metadata displays of a conversation, e.g. tagged with who spoke when, how loud, about what subject, facial expressions, camera images and video.
Review statistics over single or multiple recordings and/or communication events, such as the percentage of time involving silence/noise, time spoken by speaker X, time spoken by speakers in group Y, time language used, time with facial expressions of certain types (anger, frustration, etc), time with emotion identified through audio signal, etc.
Search any of the type of metadata mentioned above.

In some embodiments, one or more parties being recorded and/or communicating is an automated device, such as a computing device.

### Terminology and Equivalence of Systems

The description in this document and associated figures provide examples and specific potential embodiments to assist in conveying an understanding of and enabling the implementation of the inventions. One skilled in the art will understand that there are many ways to practice the invention, without many of the specific details mentioned, and with many variations in components and detailed methods used. Well known components, systems and functions are often elided since they are not necessary to enable one skilled in the art to practice the inventions. The terminology used in the description should be interpreted in the broadest reasonable manner, and the possibility of substituting equivalent technologies and standards, even when such standards do not yet exist should be recognized by one skilled in the art.

One skilled in the art should recognize, for example, that CRTs, LEDs, OLEDs, single or combined displays, displays attached to complex computing devices, displays with simple circuitry, retinal projection systems, TVs, projectors, etc., are all equivalent technologies for displaying and for people to interact with ephemeral or semi-permanent information.

Likewise, one skilled in the art should recognize that computing systems (including computation, storage/memory, communication, input, and output) for receiving input from people and for generating information for consumption by people may be realized in combined units, such as a smartphone, PDA, tablet, laptop, personal computer, mini computer, mainframe, server, virtual server, etc., or may involve distributed parts, such as computation modules packaged alone, or as part of cell phones, displays, wall-warts, tablets, laptops, personal computers, mainframes, watches, jewelry, ornaments, smart eyeglasses, smart projectors, smart tables, smart picture frames, virtual servers, cloud services, Internet services, cellular services, etc., or may involve combinations of modular or combined units, etc. Unless a specific configuration of input, output and computing units is explicitly stated to be essential to the inventions, it should be assumed that any physical configuration, communication technologies, communication patterns, etc. are possible means of practicing the inventions, with perhaps varying properties such as response times, detailed computation, availability of historical storage/memory, resolution, ergonomics, etc.

Likewise, one skilled in the art should recognize that input systems, such as computer mice, trackpads, trackballs, touch-screens, multi-touch screens, visual and other gesture analyzers, etc. are all possible means of capturing people's positional and other types of intentional input. Unless a specific type of input is required by the inventions, it should be assumed that any type or types of input are possible means of practicing the inventions.

Likewise, one skilled in the art should recognize that communication facilities, systems, protocols, etc. (for example, WiFi, RF, ZigBee, cellular, satellite, Ethernet, modems, communication over power lines, etc.) are largely interchangeable, and unless a specific type of communication system is required by the inventions, it should be assumed that any types of communication systems are possible means of practicing the inventions.

Although some functions may be described as being performed on a single device, the inventions may be equivalently practiced in distributed environments, such as networked local area computing clusters, wide area networks, the Internet, mesh networks, peer-to-peer networks, etc.

One skilled in the art will understand that computer program instructions and system data may primarily exist, be cached, be copied and distributed, etc. on single nodes in the system, or among any number of nodes. These nodes may have any combination of inputs, outputs, storage, computing facilities, communication facilities, etc.

One skilled in the art will understand that any data in the system, including computer program instructions, may be stored or distributed on tangible computer-readable storage media, such as magnetic, electronic, optical, molecular, EEPROM, SIM, nano, biological, or other media. Data may also be stored ephemerally, as ongoing transmissions, using electromagnetic, photonic, molecular, biological, and other transmission means. Data may also be distributed, as a whole, or in parts, on any storage system, such as the above storage systems, or composite and/or virtual systems, such as network storage systems.

One skilled in the art will understand that there are many available systems and methods for storing, retrieving, communicating, encrypting, sorting, analyzing, processing, transforming data, etc. that are not described herein, unless the specific method or system is necessary for the practice of the inventions.

Although specific terminology may be used and/or emphasized in the description, such terminology should be interpreted in the broadest reasonable sense, unless overtly and specifically limited to a specific interpretation in the description.

### Suitable System

The system may be implemented on any number of devices and contexts. In some embodiments, computing nodes are smartphones, tablets, laptops, computers, kiosks, headsets, earpieces, jewelry, etc., working alone, or in concert with other such devices, other different devices, and/or services provided remotely, such as peer-to-peer networks, servers, virtual servers and services, etc. Nodes in the system may be receiving and/or generating audio signals with their physical environment, e.g. a smartphone using its audio I/O capabilities, or may be a computing system not making use of I/O, such as an automaton like a telephone answering service, a note recorder, an expert system, an Internet service, a search engine, etc.

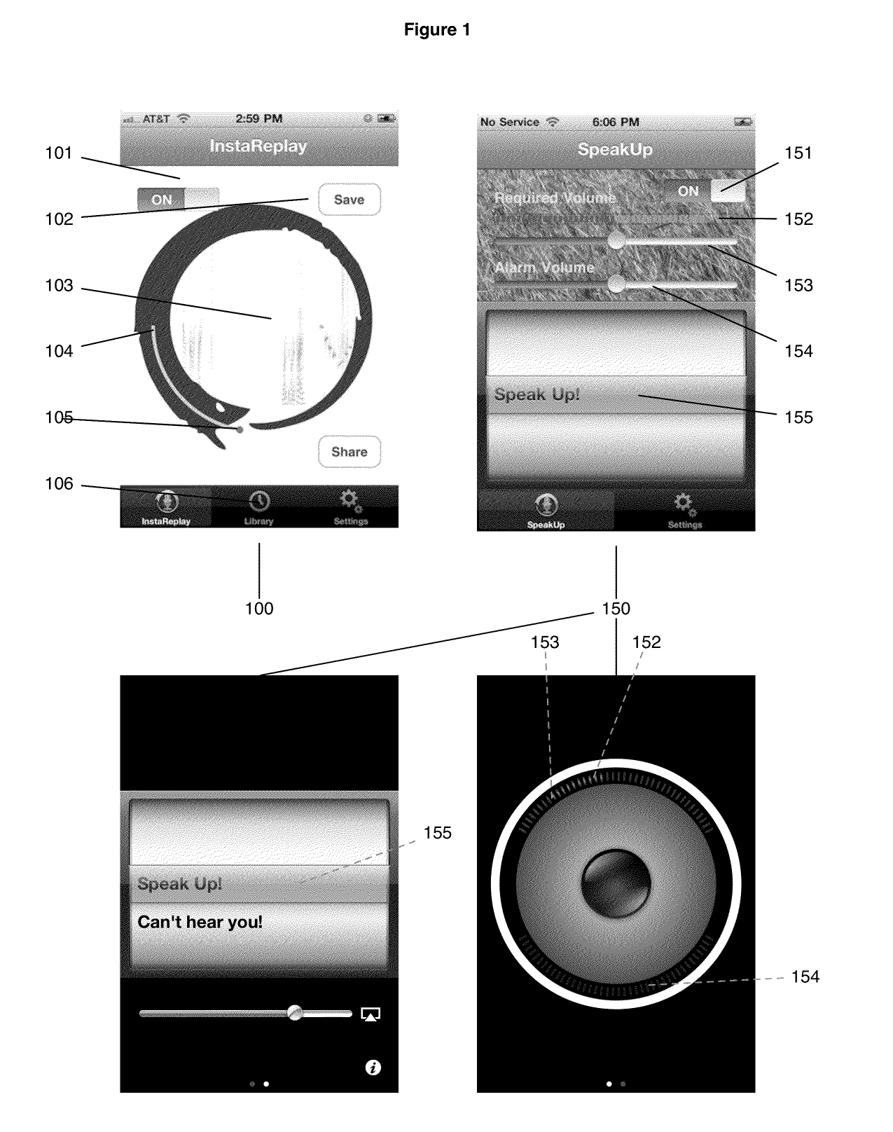

### Description of FIG. 1

As described in this document, the system may provide audio recording functionality and audio quality feedback.

Referring to FIG. 1, a user interface 100 may provide feedback and interactivity to a recording application for a smartphone. 101 shows a control that toggles that application's monitoring of the audio inputs of the smartphone. It is generally left on all the time, and consumes very little power. 102 shows a control that allows an audio recording to be explicitly saved (as opposed to implicitly, based on audio and metadata analysis). 103 shows a sonogram of audio around the current “cursor” 105 (focal point in the audio stream). The sonogram shows time along the horizontal axis, and audio intensity by frequency along the vertical axis (a sonogram). 104 shows the start of a timeline, that loops infinitely around in a circle, depicted by a rotating ouroborus, that follows the “cursor” position 105. Metadata for the audio stream (not shown) is associated with points and ranges along the timeline 104. Tab 106 is used to interact with historical recordings. Audio events, such as presence of speech and/or specific speech or other sound patterns, such as sequences of vowels, consonants, claps, snaps, whistles, etc., and/or other input, such as accelerometer data, GPS locations, etc. can trigger recording in the past, present, future, and the metadata can be used to filter (select or modify), annotate and save, ignore, queue, dequeue, modify, delete, etc., audio, metadata, and other data, such as camera images, email, tweets, postings, locations, sensor readings, etc.

Referring to FIG. 1, a user interface 150 may provide feedback and interactivity in an audio quality feedback application for a smartphone. 151 shows a control that toggles the application's monitoring of the audio inputs of the smartphone. 152 shows a linear scale of the logarithm of the volume of audio comprised of speech-related sounds in the audio input. Slider 153 allows the user to control the level of speech-related volume that is acceptably loud. Volumes above this threshold are shown in green in gauge 152. Volumes below this threshold are shown in red in gauge 152. Output/alarm volume slider 154 controls how loud a warning should be given if the speech volume falls below the set threshold for a combination of: too long, with presence of other sounds and/or identified speech-related sounds. I.e., the purpose is to signal the presence of speech-related activity that is too quiet, but without interfering too much with the ongoing conversation. 155 is a control for choosing a desired form of feedback for the system to provide when the speech volume is too low.

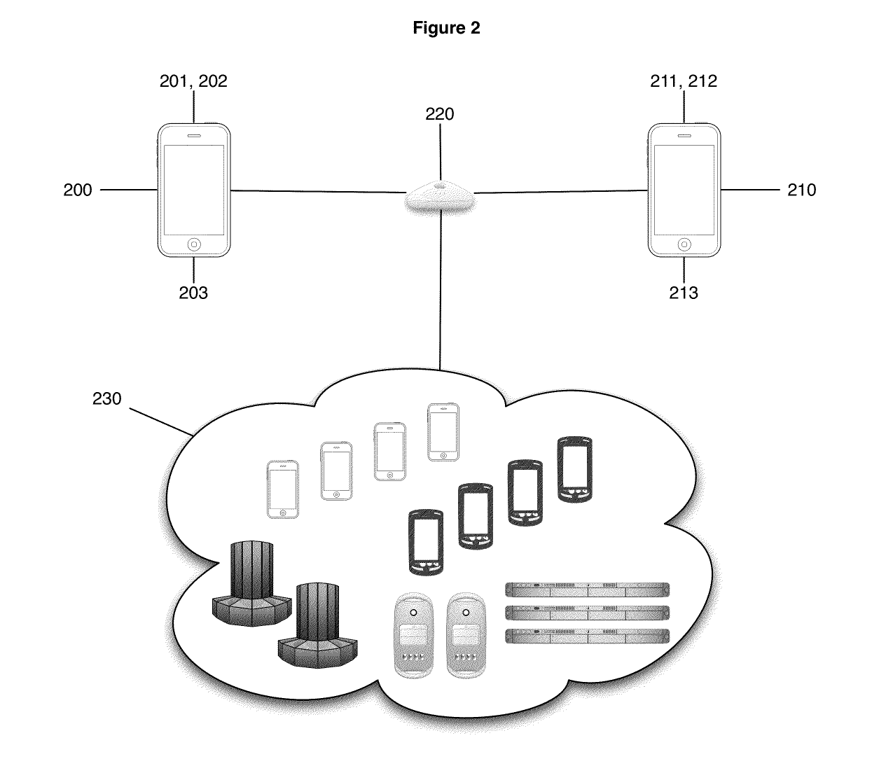

### Description of FIG. 2

As described in this document, the system may include one or more computing nodes engaged in recording and/or communicating audio, video and other types of information, such as images, text, documents, etc.

Referring to FIG. 2, a smartphone 200 is connected through a network 220 to another smartphone 210 and any other networked resources 230 (the “cloud”). Sound input is received at 203 and/or 213. It is processed in any combination of devices 200, 210, 220 and 230. Audio is generated on speakers and/or headphones 201 and/or 211. Audio can also be considered to be virtually generated on any of the devices 200, 210, 220 and 230, in cases where the received audio results in signals being generated from those devices, much like a chat-bot responding to text messages. The responses could involve audio, metadata, or other control events in the system, such as making connections, providing lists of possibly interested other parties, providing metadata about the audio signal, participants, their locations, their tasks, speed, etc. Image input devices 202 and 212 can provide images that function as metadata, or as stream data that is analyzed by the system, generating image-based metadata. Any stored, input or generated data in any of the compute nodes 200, 210, 220, 230 can also function as metadata in the system, such as tweets, Google+ posts, Facebook images, emails, web pages, translation service interactions, search engine interactions, etc.

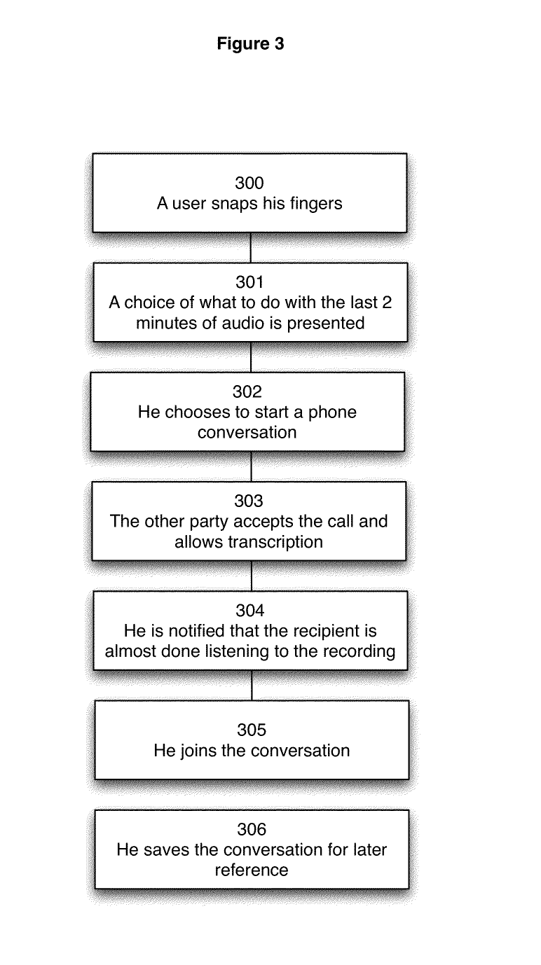

### Description of FIG. 3

As described in this document, the system may include one or more computing nodes engaged in recording and/or communicating audio, video and other types of information, such as images, text, documents, etc.

Referring to FIG. 3, a user snaps his fingers at 300, and at 301 his smartphone shows a choice of a) saving the last 2 minutes of audio, b) sharing the last 2 minutes of audio on Google+ or another web publishing platform, c) sharing the last 2 minutes transcribed with audio available as a link on Google+ or another web publishing platform, d) starting a phone, VOIP, FaceTime, or Google Hangout conversation prefaced by an introduction and metadata and a copy of the audio and metadata from the last 2 minutes. At 302, he chooses to start a phone call. At 303 the recipient chooses to receive the call and allow recording and transcription. At 304 he is notified that 15 seconds remain before the other party will complete listening to the audio, and at 305, he taps a button on the screen of his smartphone to join the conversation. At 306, he hangs up, and taps a button on the screen to log the transcript of the recording and conversation to his email account, with links to the audio and metadata.

### Sample Scenarios

In some embodiments, the system is used to monitor children playing, and provide feedback and/or notification to others of their noise level.

In some embodiments, the system is used to monitor participants in a conference, possibly involving local and remote participants, and provides feedback, notifications, and statistics on the voice level of speaking participants, and on the voice level received locally and/or at remote locations. In some embodiments, the system makes adjustments to microphone input levels, the combination/joint processing of microphone signals, their direction, amount of signal processing performed to clean the signal, etc. In some embodiments, the system provides buffering, and replay and scrubbing functionality, especially important where there is an insufficiently fast and/or reliable connection between nodes in the system. In some embodiments, the system provides real-time and/or delayed transcription, translation, and/or metadata display and interaction services.

In some embodiments, the system is used for one-to-one communication between humans, for group communications, for communications involving one or more automata/bots, for voice notes, for sound notes, for dictation, for translation, etc.

In some embodiments, the system is used by a user as an interface to remote sources of audio, such as phone calls (e.g. to filter unwanted calls), radio programs, security systems, etc. In some embodiments, the system implements automaton functionality, such as taking actions based on metadata from an incoming phone call, an image sensor, and other available data, without human involvement. Such actions may involve hanging up, transcribing, sending alerts, placing phone calls, offering phone menus, etc.

In some embodiments, the system implements security system features by providing voice and sound I/O automaton functionality, such as responding to noises and/or motion in video images, sending alerts, notifying authorities, etc.

All the ideas in this description can be applied to video streams as well, where visual entities, their motion, attributes, changes, gestures, etc. take the place of aural entities, and the system can be used with audio, video or the combination of audio and video, and metadata derived from these streams, as well as other inputs.

### Sample Components

Any electronic devices may be used with the described system. In some embodiments, microphones and speakers exist in earpieces or headphones, and computation happens mainly on a local cell phone, tablet or laptop computer, while in other embodiments, special-purpose hardware provides low-power implementations of the system, with only microphones, minimal processing power and storage, e.g. fully contained in an earpiece or a shirt button. In other embodiments, the system is built into and/or with conferencing equipment, or other special-purpose hardware. In some embodiments, generally available hardware is used, such as smartphones, tablets and computers. In some embodiments, the system provides enhancements to existing hardware and/or software solutions, such as telephones, projectors, VOIP hardware and/or software, text input/output devices, etc. In some embodiments, the system is used as an I/O system for people with disabilities, e.g. to enter text by speaking, and render received audio as text.

### CONCLUSION

In this description, figures and claims, the words “comprise,” “comprising,” and the like should be construed in as indicating possible inclusions, but not as excluding other possibilities, unless the context clearly requires otherwise.

In this description, figures and claims, the words “connected,” “coupled,” and the like should be construed as meaning any connection, whether direct, indirect, unidirectional, bidirectional, etc., between two or more elements. The connection may be logical, physical, functional, etc. or any combination thereof.

In this description, figures and claims, the words “herein,” “above,” “below,” and the like should be construed as referring to any section of the description, figures or claims.

In this description, figures and claims, words in singular or plural may also include the plural or singular number, if permitted by the context.

In this description, figures and claims, the word “or,” when referring to a list of two or more items, should be construed as covering interpretations meaning no item in the list, any item or combination of items in the list, all items in the list, as well as the possibility that there are other options. For example, if a person has the option of picking blue or yellow as a color, this would allow for a choice of no color, blue, yellow, blue and yellow, green, blue and green, etc.

This description of embodiments of the system is not intended to be exhaustive or limiting. Specific examples are provided for enablement and illustrative purposes, and, as those skilled in the relevant arts will recognize, many variations, subtractions and additions are possible within the scope of the described system. This variability potentially applies, for example, to the ordering or operations, to the serial vs. parallel handling of operations, to the specific components, their number, distribution, connection and communication patterns, to values and ranges.

We claim:

1. A computer-implemented system, comprising a first set of one or more computer nodes receiving one type of information, analyzing said information into components at different levels of abstraction, encoding said components, and transmitting said components, and a second set of one or more computer nodes receiving the transmitted components, wherein the first set encodes the information as components at more than one level of abstraction, and the second set receives components at particular levels of abstraction based on transmission conditions or by request of a computer node in the second set.

2. The system of claim 1, wherein the received information at the first set of computer nodes is audio data.

3. The system of claim 1, wherein the received information at the first set of computer nodes is video data.

4. A computer-implemented system, comprising two communicating sets of one or more computer nodes, wherein each set of computer nodes receives signals, encodes said signals, and transmits said signals to the other set of one or more computer nodes, and wherein the first set of computer nodes controls a signal input parameter of the second set of computer nodes, and the second set of computer nodes controls a signal input parameter of the first set of computer nodes.

5. The system of claim 4, wherein the received signals at the first set of computer nodes are audio data.

6. The system of claim 4, wherein the received signals at the first set of computer nodes are video data.

7. A computer-implemented system, comprising a set of one or more computer nodes receiving signals and computing a scalar quality metric that is derived from the system's success in performing higher-level analysis of the signals.

8. The system of claim 7, wherein the scalar quality metric is used to control signal input parameters.

9. The system of claim 7, wherein the received signals are audio data.

10. The system of claim 7, wherein the received signals are video data.
